(19) United States
(12) Patent Application Publication
(10) Pub. No.: US 2004/0235987 A1
(43) Pub. Date: Nov. 25, 2004

(54) Polyamide-based thermoplastic molding materials and single-piece and multiple-piece plastic shaped bodies made from said thermoplastic molding materials

(76) Inventor: Michael Fischer, Ludwigshafen (DE)

Correspondence Address: KEIL & WEINKAUF, 1350 CONNECTICUT AVENUE, N.W., WASHINGTON, DC, 20036, US

(21) Appl. No.: 10/487,547

(22) PCT Filed: Aug. 30, 2002
(86) PCT No.: PCT/EP02/09722

(30) Foreign Application Priority Data
Sep. 6, 2001 (DE) 101 43 818.4

(51) Int. Cl. C08K 9/00; C08K 3/40

(52) U.S. Cl. 523/216; 524/494

(57) ABSTRACT

Thermoplastic molding compositions comprising (A) one or more polyamides, (B) fibrous fillers treated with size, (C) straight-chain saturated carboxylic salts with chain lengths (including the terminal carboxy carbon atom) of at least 20, preferably at least 24, carbon atoms, (D) alkali metal halide and copper(I) compounds, and also, where appropriate, (E) a polyamide-soluble dye, (F) impact modifier, and/or (G) other additives, and one-piece or multipart plastic moldings, in particular hollow plastic articles, made from the molding compositions.

The present invention relates to thermoplastic molding compositions comprising

(A) one or more polyamides,

(B) fibrous fillers treated with size,

(C) straight-chain saturated carboxylic salts with chain lengths (including the terminal carboxy carbon atom) of at least 20, preferably at least 24, carbon atoms,

(D) alkali metal halide and copper(I) compounds, and also, where appropriate,

(E) a polyamide-soluble dye,

(F) impact modifier, and/or

(G) other additives.

The invention further relates to the use of these thermoplastic molding compositions for producing one-piece or multipart plastic moldings or hollow plastic articles, in particular inlet manifold modules made from plastic, and also to these plastic moldings.

Inlet manifold modules made from thermplastics, in particular from fiber-reinforced polyamides, are known to the skilled worker. Inlet manifold modules with structural elements of relatively low design complexity are generally welded together from two or more separate pieces. Vibration welding is an established method for this. However, the weld is generally the weak point in inlet manifold modules of this type, since whatever the welding process used for glass fiber-reinforced components, the glass fibers have a tendency to be transported and oriented in the direction of the melt flowing away from the jointing plane, and therefore there is low or zero proportion of glass fibers specifically in the region of the weld. Inlet manifold modules of this type therefore have a low bursting pressure. Other factors which make high bursting pressures difficult to achieve in inlet manifold modules molded from two or more plastic components are weld geometry which is not appropriate for the welding process, for example due to the absence of stiffening ribs which are usually intended to absorb the flexural load when the moldings are pressed together, and the tendency toward warpage frequently observed in the case of injection moldings, leading to non-uniform jointing distances, and also incorrect setting of the welding pressure.

WO 99/45071 describes a glassfiber-reinforced polyamide mixture made from a polycaprolactam and an aliphatic polyamide co- or terpolymer. The mixture has very good flowability and gives vibration-welded inlet manifold modules with good bursting pressure performance.

According to WO 99/16829, a mixture made from aromatic polyamides with low residual monomer contents and aliphatic polyamides gives moldings which give better welding and are hydrolysis-resistant. This is also the direction of WO 95/20630.

WO 97/10303 discloses that welded inlet manifold modules with improved bursting pressure performance are obtained using polyamide molding compositions which have small proportions of a plasticizing material. Suitable plasticizing materials mentioned are polyethylene glycol ethers, ethylene oxide derivatives, lactam derivatives, sulfonamides, esters, and diols.

WO 98/11164 specifies particularly highly suitable plastifying materials as being long-chain alkyl polyesters and low-molecular-weight polyethylene glycols, these being suitable materials for ensuring high bursting pressures in welded components.

To increase the level of efficiency of an internal combustion engine and to reduce the emission of pollutants in the exhaust gases, attempts are now being made to bring about the combustion process at very high temperatures. However, even in the absence of this technique measures such as the complete encapsulation of the engine for sound-deadening reasons are contributing to an increased temperature in the engine compartment. Another factor bringing about this effect is the constant increase in the component density in the engine compartment.

Of course, increased long-term exposure to high temperatures requires components made from highly heat-resistant materials which pass long-term tests and do not exhibit any pronounced aging. At the same time, higher operating temperatures also place higher requirements on the chemical resistance and hydrolysis resistance of the materials used. Clearly, these demanding conditions cannot be allowed to cause problems with bursting pressure.

Finally, there are also constantly increasing requirements placed upon the appearance of component surfaces in the engine compartment, since this is one method used to determine the quality of the components used.

Fusible core technology is nowadays increasingly used to produce inlet manifold modules which have complex component geometries and are of very demanding design (also “Schmelzkerntechnik für Saugrohre”, Kunststoffe, 1993, 83 (9), pp. 671-672). Fusible core technology gives hollow plastic injection moldings in a single operation and permits difficult geometries to be integrated into the overall structure prior to the conclusion of injection molding. Fusible core technology therefore generally demands a molten material which is highly flowable. However, fiber content, in particular the high fiber content needed in inlet manifold modules, considerably impairs the viscosity of the polymer melt. This means that it is essential to use high melt temperatures when producing complex inlet manifold modules with fusible core technology, e.g. those with a narrow gate or with long flow paths. The higher the temperature of the polymer melt, however, the longer the cooling time before the component can be removed from the injection mold, the result inevitably being long cycle times.

There is currently no available plastic material meeting these requirements.

It would therefore be desirable to have a plastic material which even in the presence of high proportions of glass fiber has the correct viscosity at lower melt temperatures, and which permits rapid and easy demolding. It would be particularly desirable to be able to use a plastic material which has similar and good suitability for fusible core technology and for known welding techniques.

It is an object of the present invention, therefore, to provide molding compositions which are capable of universal use in the production of plastic moldings, in particular hollow plastic articles, and permit short cycle times, and, even on long-term exposure to very high temperatures, ensure very good mechanical properties and in particular very high bursting pressure.

We have found that this object is achieved by way of thermoplastic molding compositions which comprise

(A) one or more polyamides,

(B) fibrous fillers treated with size,

(C) straight-chain saturated carboxylic salts with chain lengths (including the terminal carboxy carbon atom) of at least 20, preferably at least 24, carbon atoms,

(D) alkali metal halide and copper(I) compounds, and also, where appropriate,

(E) a polyamide-soluble dye,

(F) impact modifier, and/or

(G) other additives.

In one preferred embodiment, the thermoplastic molding compositions comprise

(A) from 1 to 99.889% by weight of polyamide,

(B) from 0.1 to 50% by weight of fibrous fillers treated with size,

(C) from 0.01 to 10% by weight of straight-chain saturated carboxylic salts with chain lengths (including the terminal carboxy carbon atom) of at least 20, preferably at least 24, carbon atoms,

(D) from 0.001 to 7% by weight of a mixture comprising alkali metal halide and copper(I) halide, and also

(E) from 0 to 3% by weight of soluble dye,

(F) from 0 to 35% by weight of impact modifiers, and/or

(G) from 0 to 30% by weight of other additives,

the total always being 100% by weight.

The invention also provides the use of these thermoplastic molding compositions for producing fibers, films, or plastic moldings, in particular for producing hollow plastic articles, e.g. inlet manifold modules. The invention further provides plastic moldings, in particular hollow plastic articles, comprising the abovementioned thermoplastic molding compositions.

As component A), the thermoplastic molding compositions of the invention comprise at least one polyamide.

Suitable polyamides are those having an aliphatic and semicrystalline or semiaromatic, or else amorphous structure of any type, and blends of these, including polyetheramides, such as polyether block amides. For the purposes of the present invention, polyamides are all known polyamides.

Polyamides of this type generally have a viscosity number of from 90 to 350 ml/g, and preferably from 110 to 240 ml/g, determined in a 0.5% strength by weight solution in 96% strength by weight sulfuric acid at 25° C. to ISO 307.

Preference is given to semicrystalline or amorphous polyamide resins with molar mass (weight-average) of at least 5000 g/mol, as described by way of example in U.S. Pat. Nos. 2,071,250, 2,071,251, 2,130,523, 2,130,948, 2,241,322, 2,312,966, 2,512,606 and 3,393,210. Examples of these are polyamides derived from lactams having from 7 to 13 ring members, e.g. polycaprolactam, polycapryllolactam, and polylaurolactam, and polyamides obtained by reacting dicarboxylic acids with diamines.

Dicarboxylic acids which may be employed are alkanedicarboxylic acids having from 6 to 12 carbon atoms, in particular from 6 to 10 carbon atoms, and aromatic dicarboxylic acids. Merely as examples, mention may be made of adipic azcid, azelaic acid, sebacic acid, dodecanedioic acid (decanedicarboxylic acid), and terephthalic and/or isophthalic acid.

Particularly suitable diamines are alkanediamines having from 6 to 12 carbon atoms, in particular from 6 to 8 carbon atoms, and m-xylylenediamine, di(4-aminophenyl)methane, di(4-aminocyclohexyl)methane, 2,2-di(4-aminophenyl)propane, or 2,2-di(4-aminocyclohexyl)propane.

Preferred polyamides are polyhexamethyleneadipamide (nylon-6,6) and polyhexamethylenesebacamide (nylon-6,10), polycaprolactam (nylon-6), and also the copolyamides nylon-6/6,6, in particular with a proportion of from 5 to 95% by weight of caprolactam units.

Particular preference is given to nylon 6, nylon-6,6, and the copolyamides nylon-6/6,6. Nylon-6 (PA 6) is very particularly referred.

Besides these, mention may also be made of polyamides obtainable, for example, by condensing 1,4-diaminobutane with adipic acid at an elevated temperature (nylon-4,6). Preparation processes for polyamides of this structure are described by way of example in EP-A 38 094, EP-A 38 582 and EP-A 39 524.

Other examples are polyamides obtainable by copolymerizing two or more of the abovementioned monomers, and mixtures of two or more polyamides, the mixing ratio being as desired.

Semiaromatic copolyamides, such as nylon-6/6,T and nylon-6,6/6,T, have also proven particularly advantageous where their triamine content is below 0.5% by weight, preferably below 0.3% by weight (see EP-A 299 444). The processes described in EP A 129 195 and 129 196 may be used to prepare the semiaromatic copolyamides with low triamine content.

The list below, which is not comprehensive, includes the polyamides mentioned and also other suitable polyamides (followed by mention of the monomers):

| | |
|---|---|
| nylon-4,6 | (tetramethylenediamine, adipic acid) |
| nylon-6,6 | (hexamethylenediamine, adipic acid) |
| nylon-6,9 | (hexamethylenediamine, azelaic acid) |
| nylon-6,10 | (hexamethylenediamine, sebacic acid) |
| nylon-6,12 | (hexamethylenediamine, decanedicarboxylic |
| | acid) |
| nylon-6,13 | (hexamethylenediamine, undecanedicarboxylic |
| | acid) |
| nylon-12,12 | (1,12-dodecanediamine, decanedicarboxylic |
| | acid) |
| nylon-13,13 | (1,13-diaminotridecane, undecanedicarboxylic |
| | acid) |
| nylon-MXD,6 | (m-xylylenediamine, adipic acid) |
| nylon-TMD,T | (trimethylhexamethylenediamine, terephthalic |
| | acid) |
| nylon-4 | (pyrrolidone) |
| nylon-6 | (ε-caprolactam) |
| nylon-7 | (ethanolactam) |
| nylon-8 | (capryllactam) |
| nylon-9 | (9-aminopelargonic acid) |
| nylon-11 | (11-aminoundecanoic acid) |
| nylon-12 | (laurolactam) |

These polyamides and their production are known. Details of their preparation can be found by the skilled worker by way of example in Ullmanns Encyklopädie der Technischen Chemie, 4^{th} edition, Vol. 19, pp. 39-54, Verlag Chemie, Weinheim 1980, and Ullmanns Encyclopedia of Industrial Chemistry, Vol. A21, S. 179-206, VCH Verlag, Weinheim 1992, and Stoeckhert, Kunststofflexikon, 8^{th} edition, pp. 425-428, Hanser Verlag, Munich, 1992 (key word “Polyamide” et seq.).

A short description is given below of the preparation of the preferred polyamides nylon-6, nylon-6,6, and the copolyamide nylon-6/6,6.

The starting monomers are preferably polymerized or polycondensed by the conventional processes. Taking caprolactam as an example, the material may be polymerized by the continuous processes described in DE-A 14 95 198 and DE-A 25 58 480. AH salt may be polymerized by the conventional batch processes to prepare nylon-6,6 (see: Polymerization Processes pp. 424-467, in particular pp. 444-446, Interscience, New York, 1977) or by a continuous process, e.g. as in EP-A 129 196.

Conventional chain regulators may be used concomitantly during the polymerization. Examples of suitable chain regulators are triacetonediamine compounds (see WO-A 95/28443), monocarboxylic acids, such as acetic acid, propionic acid, and benzoic acid, and also bases, such as hexamethylenediamine, benzylamine, and 1,4-cyclohexyldiamine. Other suitable chain regulators are C₄-C₁₀ dicarboxylic acids, such as adipic acid, azelaic acid, sebacic acid, dodecanedioic acid; C₅-C₈ cycloalkanedicarboxylic acids, such as cyclohexane-1,4-dicarboxylic acid; benzene- or naphthalenedicarboxylic acids, such as isophthalic acid, terephthalic acid, and naphthalene-2,6-dicarboxylic acid.

The resultant polymer melt is discharged from the reactor, cooled, and pelletized. The pellets obtained are subjected to post-polymerization. This proceeds in a manner known per se by heating the pellets to a temperature T below the melting point Tₘ or crystalline melting pont T_{c} of the polyamide. The post-polymerization sets the final molecular weight of the polyamide (measurable as viscosity number VN, see DN data above). The post-polymerization usually takes from 2 to 24 hours, in particular from 12 to 24 hours. Once the desired molecular weight has been achieved, the pellets are cooled in a usual manner Appropriate polyamides are obtainable from BASF with the trade name Ultramid®. Of course, it is also possible to use any desired mixture of the abovementioned types of polyamide as component A).

The thermoplastic molding composition of the invention has fibrous fillers B) which have been treated with size. The amount preferably present of the fibrous fillers in the thermoplastic molding compositions is from 0.1 to 50% by weight, particularly preferably from 10 to 45% by weight, and in particular from 25 to 40% by weight, based on the total weight of the thermoplastic molding composition.

Preferred fibrous fillers which may be mentioned are glass fibers, carbon fibers, aramid fibers, potassium titanate fibers, and basalt fibers, particular preference being given to glass fibers made from E glass. These may be used in the form of rovings or chopped glass in the forms commercially available.

To improve compatibility with the polyamide A), the fibrous fillers have been pretreated with a size. Preferred constituents of the size are silane compounds.

Suitable silane compounds are those of the formula (I)

(X—(CH₂)ₙ)ₖ—Si—(O—CₘH₂ₘ₊₁)₄₋ₖ

where:

X is

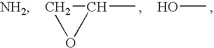

and where

n is an integer from 2 to 10, preferably 3 or 4,

m is an integer from 1 to 5, preferably 1 or 2, and

k is an integer from 1 to 3, preferably 1.

Preferred silane compounds for the coupling of the glass fiber to polyamides are aminosilane compounds, such as aminopropyltrimethoxysilane, aminobutyltrimethoxysilane, aminopropyltriethoxysilane, aminobutyltriethoxysilane, and also the corresponding silanes which contain a glycidyl group as substituent as X.

The amounts of the silane compounds generally used for surface coating are from 0.05 to 5% by weight, preferably from 0.5 to 1.5% by weight, and in particular from 0.8 to 1% by weight (based on B).

Besides the silane compounds, the size preferably also comprises polymeric film-forming additives, such as polyurethanes. The proportion of polymeric film-formers is preferably in the range from 5 to 15% by weight, based on the total weight of the size. The size particularly preferably has chain extenders. Examples of chain extenders which may be used are inorganic compounds, such as hypophosphites, e.g. alkali metal hypophosphites or alkaline earth metal hypophosphites, such as sodium hypophosphite or magnesium hypophosphite, where appropriate also in the form of monohydrate, or organic compounds which can react with polyamides to give chain extension. Examples of organic compounds included here are compounds which contain at least one, preferably at least two, functional groups reactive toward polyamides, such as the epoxy, hydroxyl, ester, carboxy, or maleic anhydride group, alone or in a mixture. Compounds with acidic H atoms are also included, e.g. 2-ethylalkyl esters of polyethylene glycol. Surface-active substances and/or antistats may also be added to the size.

Preference is given to fibrous fillers with a numeric median fiber length of from 150 μm to 10 mm, preferably from 200 μm to 7 mm, and in particular from 220 μm to 5 mm. The median diameter is generally from 3 to 30 μm, preferably from 5 to 20 μm, and in particular from 8 to 14 μm. One way of adjusting to the desired fiber length is milling in a ball mill, which produces a distribution of fiber lengths.

If the median fiber length is <200 μm, further reduction of fiber length gives a free-flowing loose material which is similar to a powder in its capability for incorporation into the polymer. Since the fiber length is low, only slight further shortening of the fiber length occurs on incorporation.

The fiber content is usually determined after ashing of the polymer. To determine the distribution of fiber length, the residue from ashing is generally taken up in silicone oil, and a micrograph is taken with an enlargement factor of 20. The length of at least 500 fibers may be measured on the images and used to calculate the numeric median (d₅₀).

A particularly suitable glass fiber B) which has been treated with size is the chopped glass fiber of the commercially available Chop Vantage® products 3540, 3545, 3660 and 3786 from the company PPG Industries Inc.

Acicular mineral fillers are also suitable, and for the purposes of the present invention these are mineral fillers with markedly acicular character. An example which may be mentioned is acicular wollastonite. The mineral preferably has an L/D (length/diameter) ratio of from 8:1 to 35:1, preferably from 8:1 to 11:1. Unless a fiber treated with size is used at the same time, the mineral filler has likewise been pretreated with the abovementioned size.

Suitable particulate fillers are amorphous silicas, magnesium carbonate, chalk, kaolin (in particular calcined kaolin), powdered quartz, mica, talc, feldspar, and in particular calcium silicates, such as wollastonite.

It is also possible to use any desired mixture of fibers and/or fillers.

As component C), the molding compositions of the invention comprise straight-chain saturated carboxylic salts with chain lengths (including the terminal carboxy carbon atom) of at least 20, and preferably at least 24, carbon atoms. Suitable amounts are in the range from 0.01 to 10% by weight, preferably from 0.05 to 1.5% by weight, and particularly preferably from 0.1 to 0.5% by weight, based on the total weight of thermoplastic molding compositions. Particular preference is given to the salts of montanic acid, and for the purposes of the present invention montanic acid is both the compound CH₃(CH₂)₂₆CO₂H and a mixture of straight-chain saturated fatty acids having from 24 to 32 carbon atoms. The cationic counterions in the carboxylic salts mentioned are preferably alkali metal cations or alkaline earth metal cations, such as lithium, sodium, or calcium. Of course, it is also possible to use the aluminum cation or transition metal cations, such as zinc, or non-metallic cations, such as ammonium ions, phosphonium ions, or arsenium ions. The cations of the alkaline earth metals are particularly suitable, in particular the calcium cation. It is also possible to use any desired mixture of the abovementioned straight-chain saturated carboxylic salts. In one particularly preferred embodiment, component C) uses calcium montanate. Products of this type are available commercially, e.g. with the name Licomont VaV 102 (Clariant).

As component D), the thermoplastic molding compositions of the invention comprise a mixture of copper(I) compounds and alkali metal halides. Suitable amounts of this mixture begin at 0.05% by weight and are preferably in the range from 0.05 to 7% by weight, particularly preferably from 0.3 to 5% by weight, and in particular from 0.5 to 3% by weight, based on the total weight of the thermoplastic molding composition. The form in which the copper(I) compounds are introduced into the thermoplastic molding compositions is advantageously that of copper(I) halides. The copper(I) halides used are preferably copper(I) chloride and copper(I) bromide, and in particular copper(I) iodide, or a mixture of these. Together with the copper(I) compounds, component D) uses alkali metal halides. Suitable alkali metal halides are the fluorides, chlorides, bromides, and iodides of lithium, of sodium, of potassium, and of cesium. It is preferable to utilize potassium iodide, and in particular potassium bromide. It is also possible to use a mixture of alkali metal halides. In the stabilizer mixture described above there is advantageously a molar excess of the alkali metal halides. The molar ratio of alkali metal halides to copper halides is therefore preferably in the range from 10:1 to 1:100, and particularly preferably in the range from 1:1 to 1:50. Thermoplastic molding compositions which have proven particularly suitable are those in which copper is present in the form of a copper(I) compound, the amount being at least 10 ppm, based on the total weight of the thermoplastic molding composition. This amount of copper is preferably in the range from 50 to 1000 ppm, particularly preferably in the range from 80 to 500 ppm, and in particular in the range from 250 to 400 ppm.

In another embodiment, triphenylphosphine may also be used concomitantly as a stabilizer constituent in addition to the alkali metal halides.

The thermoplastic molding compositions of the invention may moreover comprise, as component E), up to 5% by weight, particularly prefrably up to 2% by weight, based on the total weight of the thermoplastic molding composition, of soluble dye. These are dyes soluble in the polyamide A). Examples of suitable soluble dyes are organic compounds containing a chromophor, for example amine dyes, such as the commercially available product Nigrosin.

Impact modifiers (component F)) may be present in the molding compositions of the invention, the amounts being up to 35% by weight, preferably up to 25% by weight. The skilled worker also uses the terms elastomeric polymers, elastomers, or rubbers to mean impact modifiers.

These are very generally copolymers preferably built up from at least two of the following monomers: ethylene, propylene, butadiene, isobutene, isoprene, chloroprene, vinyl acetate, styrene, acrylonitrile and (meth)acrylates having from 1 to 18 carbon atoms in the alcohol component.

Polymers of this type have been described, for example, in Houben-Weyl, Methoden der organischen Chemie, Vol. 14/1 (Georg-Thieme-Verlag, Stuttgart, 1961), pages 392-406, and in the monograph by C. B. Bucknall, “Toughened Plastics” (Applied Science Publishers, London, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, or mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride. Copolymers of ethylene with acrylic acid and/or methacrylic acid and/or with the esters of these acids are another group of preferred rubbers. The rubbers may also include dicarboxylic acids, such as maleic acid and fumaric acid, or derivatives of these acids, e.g. esters and anhydrides, and/or monomers containing epoxy groups. These monomers containing dicarboxylic acid derivatives or containing epoxy groups are preferably incorporated into the rubber by adding to the monomer mixture monomers M containing dicarboxylic acid groups and/or epoxy groups

Preferred dicarboxylic acid or epoxy monomers are maleic acid, maleic anhydride and (meth)acrylates containing epoxy groups, such as glycidyl acrylate and glycidyl methacrylate, and the esters with tertiary alcohols, such as tert-butyl acrylate. Although the latter have no free carboxyl groups their behavior approximates to that of the free acids and they are therefore termed monomers with latent carboxyl groups.

The copolymers are advantageously composed of from 50 to 98% by weight of ethylene, from 0.1 to 20% by weight of monomers containing epoxy groups and/or methacrylic acid and/or monomers containing anhydride groups, the remaining amount being (meth)acrylates.

Other preferred (meth)acrylates are the methyl, ethyl, propyl, isobutyl and tert-butyl esters, and other comonomers which may be used are vinyl esters and vinyl ethers.

The ethylene copolymers described above may be prepared by processes known per se, preferably by random copolymerization at high pressure and elevated temperature. Appropriate processes are well known.

Other preferred elastomers are emulsion polymers whose preparation is described, for example, by Blackley in “Emulsion Polymerization”, Applied Science Publishers, London 1975. The emulsifiers and catalysts which may be used are known per se.

In principle, either elastomers with a homogeneous structure or those with a shell structure may be employed. The shell-type structure is a function of the addition sequence of the individual monomers. The morphology of the polymers is also influenced by this addition sequence.

Compounds which may be mentioned merely as examples of monomers for preparing the rubber part of the elastomers are acrylate, for example n-butyl acrylate and 2-ethylhexyl acrylate, the corresponding methacrylates, butadiene and isoprene, and mixtures of these. These monomers may be copolymerized with other monomers, such as styrene, acrylonitrile, vinyl ethers, or with other acrylates or methacrylates, such as methyl methacrylate, methyl acrylate, ethyl acrylate, or propyl acrylate.

The soft or rubber phase (with a glass transition temperature less than 0° C.) of the elastomers can be the core, the outer envelope, or an intermediate shell (in elastomers whose structure has more than two shells). Elastomers having two or more shells may also have two or more shells made from a rubber phase.

If one or more hard components (with glass transition temperatures of greater than 200° C.) are involved, besides the rubber phase, in the structure of the elastomer, these are generally prepared by polymerization of styrene, acrylonitrile, methacrylonitrile, α-methylstyrene, p-methylstyrene, or of acrylates or methacrylates, such as methyl acrylate, ethyl acrylate, or methyl methacrylate, as main monomers. Besides these, smaller amounts of other comonomers may also be employed.

In a number of cases, it has proven advantageous to employ emulsion polymers having reactive groups at the surface. Examples of groups of this type are epoxy, carboxy, latent carboxy, amino, and amide groups, and functional groups which can be introduced by incorporation of monomers of the formula (II)

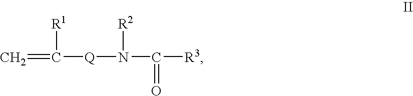

where

R¹ is hydrogen or C₁-C₄-alkyl,

R² is hydrogen, C₁-C₈-alkyl, or aryl, in particular phenyl,

R³ is hydrogen, C₁-C₁₀-alkyl, C₆-C₁₂-aryl, or —OR

R⁴ is C₁-C₈-alkyl or C₆-C₁₂-aryl, each of which may have been substituted with oxygen- or nitrogen-containing groups,

Q is a chemical bond, C₁-C₁₀-alkylene, or C₆-C₁₂-arylene, or

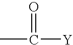

Y is O-Z or NH-Z, and

Z is C₁-C₁₀-alkylene or C₆-C₁₂-arylene.

The graft monomers described in EP-A 208 187 are also suitable for introducing reactive groups on the surface.

Other examples are acrylamide, methacrylamide, and substituted acrylates and methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The constituents of the rubber phase may also have been crosslinked. Examples of monomers which act as crosslinkers are 1,3-butadiene, divinylbenzene, diallyl phthalate, dihydrodicyclopentadienyl acrylate, and the compounds described in EP-A 50 265.

Use may also be made of graft-linking monomers, i.e. monomers having two or more polymerizable double bonds which react at different rates during polymerization. Preference is given to compounds of this type in which at least one reactive group polymerizes at about the same rate as the remaining monomers, whereas the other reactive group(s), for example, polymerize(s) significantly more slowly. The different polymerization rates give rise to a certain proportion of unsaturated double bonds in the rubber. If a further phase is then grafted onto a rubber of this type, at least some of the double bonds in the rubber react to form chemical bonds with the graft monomers, i.e. the grafted phase has at least some extent of linkage via chemical bonds to the graft base.

Examples of graft-linking monomers of this type are allyl-containing monomers, in particular allyl esters of ethylenically unsaturated carboxylic acids, for example allyl acrylate, allyl methacrylate, diallyl maleate, diallyl fumarate, diallyl itaconate, and the corresponding monoallyl compounds of these dicarboxylic acids. There are also many other suitable graft-linking monomers, and further details may be found in U.S. Pat. No. 4,148,846, for example.

The proportion of these crosslinking monomers in the impact-modified polymer is generally up to 5% by weight, preferably not more than 3% by weight, based on the impact-modified polymer.

Some preferred emulsion polymers will be listed below. Mention will firstly be made here of graft polymers with a core and at least one outer envelope and the following structure:

| Type | Monomers for core | Monomers for envelope |
|---|---|---|
| I | 1,3-butadiene, isoprene, | Styrene, acrylonitrile, |
| | n-butyl acrylate, | methyl methacrylate |
| | ethylhexyl acrylate or a | |
| | mixture of these | |
| II | as I but with concomitant | as I |
| | use of crosslinkers | |
| III | as I or II | n-butyl acrylate, ethyl |
| | | acrylate, methyl acrylate, |
| | | 1,3-butadiene, isoprene, |
| | | ethylhexyl acrylate |
| IV | as I or II | as I or III but with |
| | | concommitant use of |
| | | monomers having reactive |
| | | groups as described herein |
| V | Styrene, acrylonitrile, | first envelope made from |
| | methyl methacrylate or a | monomers as described |
| | mixture of these | under I and II for the |
| | | core |
| | | second envelope as |
| | | described under I or IV |
| | | for the envelope |

Instead of graft polymers having a structure of two or more shells, it is also possible to use homogeneous, i.e. single-shell, elastomers made from 1,3-butadiene, isoprene, and n-butyl acrylate, or copolymers of these. These products may also be prepared with incorporation of crosslinking monomers or of monomers having reactive groups.

Examples of preferred emulsion polymers are n-butyl acrylate-(meth)acrylic acid copolymers, n-butyl acrylate-glycidyl acrylate copolymers, n-butyl acrylate-glycidyl methacrylate copolymers, graft polymers having an inner core made from n-butyl acrylate or based on butadiene and having an outer envelope made from the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

As component G), the molding compositions of the invention may comprise up to 30% by weight, preferably up to 15% by weight, of other additives.

An example which may be mentioned is from 0 to 2% by weight of fluorine-containing ethylene polymers. These are polymers of ethylene with a fluorine content of from 55 to 76% by weight, preferably from 70 to 76% by weight.

Examples of these are polytetrafluoroethylene (PTFE), tetrafluoroethylene copolymers, and tetrafluoroethylene copolymers with relatively small proportions (generally up to 50% by weight) of copolymerizable ethylenically unsaturated monomers. An example of a description of these is that by Schildknecht in “Vinyl and Related Polymers”, Wiley-Verlag, 1952, pp. 484-494, and from Wall in “Fluorpolymers” (Wiley Interscience, 1972).

These fluorine-containing ethylene copolymers have homogeneous distribution in the molding compositions and preferably have a d₅₀ particle size (numeric median) in the range from 0.05 to 10 μm, in particular from 0.1 to 5 μm. These small particle sizes may particularly preferably be achieved by using aqueous dispersions of fluorine-containing ethylene polymers and incorporating these into a polyamide melt, for example.

Other additives which may be mentioned are heat stabilizers, light stabilizers, lubricants, mold-release agents, and colorants, such as insoluble dyes and pigments, the amounts being those which are usual.

The amounts generally present of additional pigments and insoluble dyes in the thermoplastic molding compositions are up to 2% by weight, preferably up to 1% by weight, and in particular up to 0.5% by weight. Pigments of this type give, for example, greater color depth or a variety of mattness grades of a black color and are well known, for example from R. Gächter and H. Müller, Taschenbuch der Kunststoffadditive,

Carl Hanser Verlag, 1983, pp. 494-510. A first preferred group of pigments is that of white pigments, such as zinc oxide, zinc sulfide, white lead (PbCO₃.Pb(OH)₂), lithopones, antimony white, and titanium dioxide. Of the two most common crystalline forms of titanium dioxide (rutile and anatase) it is in particular the rutile form which is used to adjust the appearance of the molding compositions of the invention.

Black pigments which may be used according to the invention are iron oxide black (Fe₃O₄), Spinell black (Cu,(Cr,Fe)₂O₄), manganese black (a mixture of manganese dioxide, silicon dioxide and iron oxide), cobalt black, and antimony black, and particularly preferably carbon black, mostly used in the form of furnace black or gas black (see in this connection G. Benzing, Pigmente für Anstrichmittel, Expert-Verlag (1988), pp. 78 et seq. Examples of oxidation retarders and heat stabilizers which may be added to the thermoplastic compositions of the invention are zinc fluoride and zinc chloride. It is also possible to use sterically hindered phenols, hydroquinones, substituted representatives of this group, secondary aromatic amines, where appropriate combined with phosphorus-containing acids or salts of these, the stabilizers known as HALS types (hindered amine light stabilizer), or a mixture of these compounds, preferably at concentrations of up to 1% by weight, based on the weight of the mixture. Synergistic components, such as triphenylphosphine, may also be used.

Examples of UV stabilizers are various substituted resorcinols, salicylates, benzotriazoles, and benzophenones, usually in amounts of up to 2% by weight.

Examples of antistats are the diethanolamine derivative of coconut oil and sodium alkylsulfonates.

Lubricants and mold-release agents, which are generally added in amounts of up to 1% by weight to the thermoplastic molding composition, are stearic acid, stearyl alcohol, octadecyl alcohol, alkyl stearates, stearamides, ethylenebisstearylamide, and also esters of pentaerythritol with long-chain fatty acids. It is also possible to use stearates of calcium, of zinc, or of aluminum, or else dialkyl ketones, e.g. distearyl ketone.

Examples of flame retardants are red phosphorus, phosphorus compounds, melamine cyanurate, alkaline earth carbonates, magnesium hydroxide, and halogenated flame retardants, such as decabromodiphenylethane, the amounts of these which may be used being up to 20% by weight, preferably up to 15% by weight.

The additives also include stabilizers which prevent the decomposition of the red phosphorus in the presence of moisture and atmospheric oxygen. Examples of these are compounds of cadmium, of zinc, of aluminum, of tin, of magnesium, of manganese, and of titanium. Examples of particularly suitable compounds are oxides of the metals mentioned, and also carbonates and oxycarbonates, hydroxides, and also salts of organic or of inorganic acids, for example acetates, phosphates, or hydrogen phosphates.

Low-molecular-weight polymers are also possible additives, and particular preference is given to polyethylene wax as a lubricant.

Other additives which may be used are inorganic or organic chain extenders, such as sodium hypophosphite (where appropriate in the form of monohydrate) or polymers having end groups reactive toward polyamides, for example epoxy, hydroxyl, ester, or carboxy end groups, and compounds having acidic H atoms, e.g. 2-ethylalkyl esters of polyethylene glycol.

The molding compositions of the invention may be prepared by processes known per se. For example, all of the components A) to d) and, where appropriate, E) to G) may be mixed dry and then melted and converted into the thermoplastic molding compositions of the invention. It is also possible for the sized glass fibers to be present in the polyamide pellets when they are used. In one preferred embodiment, the preparation adds components B) to D), and also where appropriate E) to G), to the melt of component A). In one preferred embodiment here, component B) and where appropriate F) are fed separately into the melt of component A). Components C) and D), and also where appropriate E) and G), may be introduced separately into the melt, or more preferably in the form of a premix. It is advantageous to use extruders for this purpose, e.g. single-screw or twin-screw extruders, or other conventional plastifying devices, such as Brabender mixers or Banbury mixers.

The resultant polyamide mixture may where appropriate be subjected to another thermal treatment, i.e. a solid-phase post-condensation. The molding composition, in the form appropriate to the process, is conditioned in a conditioning apparatus, for example a tumbling mixer or a continuous or batch conditioning tube, until the desired viscosity number VN has been reached. The temperature range for the conditioning depends on the melting point of the pure component A). Preferred temperature ranges for conditioning are below the respective melting point of A) by from 5 to 50° C., preferably from 20 to 30° C. The conditioning process is preferably carried out in an inert gas atmosphere, preferred inert gases being nitrogen and superheated steam. The residence times are generally from 0.5 to 50, preferably from 4 to 20 hours.

The invention also provides plastic moldings, in particular hollow plastic articles, made from the molding compositions of the invention. The hollow plastic articles may either be produced in one piece by fusible core technology or else from two or more plastic moldings by means of welding techniques known to the skilled worker, such as ultrasound welding, laser welding, heated-tool welding, or vibration welding. The subject matter of the invention also includes plastic components which encompass two or more plastic moldings containing the molding compositions of the invention and welded by one of the above-mentioned processes. When these plastic components are produced, polymer melts made from the molding compositions of the invention with high viscosity are found in the region of the weld. Very high entanglement density is achieved in the region of the weld or joint using the molding compositions of the invention. Plastic moldings welded by the processes described above give plastic components with very good stability and strength in the region of the joint.

The thermoplastic molding compositions of the invention have very good flowability. Melt stability is excellent under conventional processing conditions and is substantially independent of the conditions selected. These molding compositions can be used to obtain plastic moldings, e.g. hollow plastic articles with extremely good surface, which have superb mechanical properties, e.g. very high bursting pressure, retained even on long-term stressing with high temperatures.

The thermoplastic molding compositions of the invention are therefore suitable for producing fibers, films, or plastic moldings of any type. The moldings obtained using the thermoplastic molding compositions of the invention have very smooth surfaces unimpaired by any glass fiber ends protruding from the surface. No graying effect attributable to these glass fiber ends is found. Plastic moldings produced from these thermoplastic molding compositions of the invention have markedly improved impact strength (determined to ISO 179/1eU), and also markedly improved tensile strength (determined to ISO 527-2), and indeed both prior to and after heat-ageing, e.g. at 150° C. for a period of 1000 h in a circulating-air heating cabinet. The molding compositions of the invention are also particularly suitable for producing hollow plastic articles, such as inlet manifold modules. These hollow plastic articles, for example hollow spherical articles vibration-welded from two half shells, have markedly improved bursting pressure—again both prior to and after the heat-ageing described above. Improvements in the range from 10 to 20% or even greater are readily achievable in the abovementioned parameters of impact strength, tensile strength, and bursting pressure. Another advantage is that highly resistant hollow plastic articles or plastic components may be obtained equally well by fusible core technology or by means of appropriate welding processes. For example, the molding compositions of the invention permit hollow articles with complex geometry, e.g. very narrow flow paths or very narrow gates, to be obtained via fusible core technology. Another advantage is that the plastic injection moldings can be demolded at very high temperatures without damage, and therefore permit very short cycle times. These very short cycle times mean that the thermoplastic molding compositions of the invention may also be used for what is known as on-line manufacturing, i.e. direct integration of the plastic injection molding or hollow injection-molded plastic article into an automated production process, for example that for an inlet manifold module, with no intermediate storage.

### EXAMPLE 1

| | |
|---|---|
| Component A): | polycaprolactam with a relative solution |
| | viscosity RV (1.0 g/dl) of 2, 73 |
| Component B): | PPG 3660 chopped glass fiber from PPG Fiber Glass |
| Component C): | calcium montanate |
| Component D): | CuI/KI complex (molar ratio 1/5) |
| Component G): | BP 880 carbon black pigment |

64.147% by weight of component A, 35% by weight of B, 0.35% by weight of C, 0.003% by weight of Cu in the form of component D, and 0.5% by weight of G, in each case based on the total weight of all the components, were mixed at 275° C. in a Werner & Pfleiderer ZSK 40 twin-screw extruder.

The resultant pellets were processed to give test specimens as in ISO 179/1eU, and these were used to determine impact strength. Average impact strength from determinations on 10 test specimens was 109 kJ/m².

### COMPARATIVE EXAMPLE

Test specimens were produced as described in example 1, but PPG 3545 chopped glass fiber from PPG Fiber Glass was used instead of the component B used in example 1, and calcium stearate was used instead of the component C used in example 1. Average impact strength was 85 kJ/m².

We claim:

1. A thermoplastic molding composition comprising
(A) one or more polyamides,
(B) fibrous fillers treated with size,
(C) straight-chain saturated carboxylic salts with chain lengths (including the terminal carboxy carbon atom) of at least 20, preferably at least 24, carbon atoms,
(D) alkali metal halide and copper(I) compounds, and also, where appropriate,
(E) a polyamide-soluble dye,
(F) impact modifier, and/or
(G) other additives.

2. A thermoplastic molding composition comprising
(A) from 1 to 99.889% by weight of polyamide,
(B) from 0.1 to 50% by weight of fibrous fillers treated with size,
(C) from 0.01 to 10% by weight of straight-chain saturated carboxylic salts with chain lengths (including the terminal carboxy carbon atom) of at least 20, preferably at least 24, carbon atoms,
(D) from 0.001 to 7% by weight of a mixture comprising alkali metal halide and copper(I) halide, and also
(E) from 0 to 3% by weight of soluble dye,
(F) from 0 to 35% by weight of impact modifiers, and/or
(G) from 0 to 30% by weight of other additives,
the total always being 100% by weight.

3. A thermoplastic molding composition as claimed in claim 1 or 2, wherein the polyamide used comprises a polycaprolactam (nylon-6) or a polyhexamethyleneadipamide (nylon-6,6).

4. A thermoplastic molding composition as claimed in any of claims 1 to 3, wherein the glass fiber used comprises a type E glass fiber.

5. A thermoplastic molding composition as claimed in any of claims 1 to 4, wherein the straight-chain unsaturated carboxylic salt used is a salt of montanic acid.

6. A thermoplastic molding composition as claimed in any of claims 1 to 5, wherein the soluble dye used comprises nigrosin.

7. A thermoplastic molding composition as claimed in any of claims 1 to 6, which comprises at least 10 ppm, in particular from 250 to 400 ppm, based on the total weight of the thermoplastic molding composition, of a copper(I) compound.

8. The use of the thermoplastic molding compositions as claimed in any of claims 1 to 7 for producing fibers, films, or plastic moldings.

9. The use as claimed in claim 8, where the plastic molding is a hollow plastic article, in particular an inlet manifold module or a component of the same.

10. A plastic molding or a one-piece hollow plastic article, in particular an inlet manifold module, comprising thermoplastic molding compositions as claimed in any of claims 1 to 7.

11. A plastic component, in particular a multipart hollow plastic article, encompassing at least two plastic moldings comprising thermoplastic molding compositions as claimed in any of claims 1 to 7 and bonded by means of ultrasound welding, laser welding, heated-tool welding or vibration welding.
